(19) United States
(12) Patent Application Publication
(10) Pub. No.: US 2014/0241368 A1
(43) Pub. Date: Aug. 28, 2014

(54) CONTROL APPARATUS FOR FORWARDING APPARATUS, CONTROL METHOD FOR FORWARDING APPARATUS, COMMUNICATION SYSTEM, AND PROGRAM

(71) Applicant: NEC CORPORATION, Tokyo (JP)

(72) Inventors: Kazuya Suzuki, Tokyo (JP); Hideyuki Shimonishi, Tokyo (JP)

(73) Assignee: NEC CORPORATION, Tokyo (JP)

(21) Appl. No.: 14/352,307

(22) PCT Filed: Oct. 19, 2012
(86) PCT No.: PCT/JP2012/006714

§ 371 Date: Apr. 16, 2014

(30) Foreign Application Priority Data
Oct. 21, 2011 (JP) 2011-231820

(51) Int. Cl. H04L 12/741

(52) U.S. Cl. CPC H04L 45/74
USPC 370/392

(57) ABSTRACT

A control apparatus for forwarding apparatuses is connected to forwarding apparatuses which forward a packet according to a forwarding rule and includes: an address storage unit that stores correspondence relationships between upper layer addresses and lower layer addresses; an address management unit that refers to the address storage unit to search for a corresponding lower layer address from an upper layer destination address of a packet to be forwarded through one or more of the forwarding apparatuses; and a forwarding rule setting unit that sets a forwarding rule for causing the one or more forwarding apparatuses on a forwarding path of the packet to be forwarded to perform a process of writing the searched lower layer address in a lower layer destination address field of the packet to be forwarded.

### CROSS-REFERENCE TO RELATED APPLICATIONS

The present invention is based upon and claims the benefit of the priority of Japanese Patent Application No. 2011-231820 (filed on Oct. 21, 2011), the disclosure of which is incorporated herein in its entirety by reference.

### TECHNICAL FIELD

The present invention relates to a control apparatus for a forwarding apparatus, a control method for the forwarding apparatus, a communication system, and a program. The invention relates to a control apparatus for a forwarding apparatus that controls the forwarding apparatus for forwarding a packet according to a forwarding rule, a control method for the forwarding apparatus, a communication system, and a program

### BACKGROUND ART

A communication system referred to as OpenFlow that implements communication between an OpenFlow switch (hereinafter referred to as an “OFS”) and an OpenFlow controller (hereinafter referred to as an “OFC”) is described in Non Patent Literatures 1 and 2. The OFS and the OFC will be outlined below.

The OFS is a forwarding apparatus specified in Non Patent Literature 2 including a flow table and a secure channel for communication with the controller. The flow table stores a forwarding rule (flow entry) where match fields (Match Fields) to be matched against header information of a received packet and processing contents (Instructions) are associated. The OFC is a control apparatus that communicates with the OFS over the secure channel, using an OpenFlow protocol described in Non Patent Literature 2, and controls a flow at an API (Application Programming Interface) level, for example.

The OFS and the OFC operate, as follows, for example.

When a first packet (First packet) arrives at the OFS, the OFS searches the flow table for a forwarding rule (flow entry) with match fields (Match Fields) matching header information on the packet. When the matching flow entry is not found as the result of the search, the OFS forwards the packet to the OFC over the secure channel.

The OFC identifies the OFSs that will serve as a start point and an end point based on information on a destination and a transmission source included in the header information of the packet, and then further determines the path (forwarding path) of the packet by referring to network topology information. Next, the OFC sets a forwarding rule (flow entry) for executing forwarding of the packet along the path (forwarding path) in the flow table of each of the OFSs on the determined path (forwarding path). Second and subsequent packets are forwarded from the OFS to the OFS on the path (forwarding path) according to the forwarding rule (flow entry) that has been set.

FIG. 18 is a diagram schematically showing the flow table of each OFS. As shown in FIG. 18, each forwarding rule (flow entry) stored in a flow table 100 is constituted from match fields (Match Fields) to be matched against header information of a received packet, instructions (Instructions, also referred to as “Actions”) defining processing content to be applied to a packet matching the match fields (Match Fields), and flow statistical information (Counters).

Exact values (Exact) and wildcards (Wildcard) can be specified in the match fields (Match Fields). A preset field of the packet header is used for matching against the match fields (Match Fields). As the information used for the match, in addition to MAC DA (Media Access Control Destination Address), MAC SA (MAC Source Address), Ethernet (trademark) type (TPID), VLAN ID (Virtual Local Area Network ID), VLAN TYPE (priority level), IP SA (Internet Protocol Source Address), IP DA (IP Destination Address), IP protocol, Source Port (TCP/UDP source port or ICMP (Internet Control Message Protocol) Type), and Destination port (TCP/UDP destination port or ICMP Code), information on an input port (Ingress Port) and metadata and the like of the OFS can be specified.

FIG. 20 shows examples of processing contents that can be set in the field of instructions (Instructions) of each forwarding rule (flow entry). OUTPUT means outputting a packet to a specified port (interface). SET_VLAN_VID down to SET_TP_DST mean actions for correcting the fields of the packet header.

The OFS can also forward a packet to a virtual port as well as a physical port. FIG. 21 shows examples of virtual ports illustrated in Non Patent Literature 2. IN_PORT indicates a virtual port name for instructing transmission through an input port. NORMAL indicates a virtual port name for instructing packet processing using a non-OpenFlow pipeline. FLOOD indicates a virtual port name for instructing forwarding the packet from all ports in a communication enabled state (Forwarding state) except a port which has received the packet. ALL indicates a virtual port name for instructing forwarding of the packet from the ports except the port which has received the packet. CONTROLLER indicates a virtual port name for instructing encapsulation of the packet and transmission of the encapsulated packet to the controller. LOCAL indicates a virtual port name for instructing transmission of the packet to a local network stack of the switch itself.

When no processing content is specified in the field of instructions (Instructions) of the forwarding rule (flow entry), the packet that has matched the forwarding rule (flow entry) is dropped (discarded).

FIG. 22 illustrates messages to be exchanged between an OFS and the OFC through the secure channel. Flow-mod indicates a message to be sent from the OFC to the OFS, for adding, modifying, or deleting a forwarding rule (flow entry). Packet-in indicates a message to be sent from the OFS to the OFC, and is used for sending a packet that has not matched a forwarding rule (flow entry). Packet-out indicates a message to be sent from the OFC to the OFS, and is used for outputting a packet generated by the OFC from an arbitrary port of the OFS.

The flow statistical information (counters) in FIG. 18 is also referred to as activity counters, and includes the number of active entries, the number of times of packet lookups, and the number of packet matches. The flow statistical information also includes, for each flow, the number of received packets, the number of received bytes, and an active period of the flow. The flow statistics information also includes, for each port, the number of received packets, the number of transmitted packets, the number of received bytes, the number of transmitted bytes, the number of reception drops, the number of transmission drops, the number of reception errors, the number of transmission errors, the number of received frame alignment errors, the number of reception overrun errors, the number of reception CRC errors, and the number of collisions.

### CITATION LIST

### Non Patent Literature

NPL 1: Nick McKeown and seven other authors, “OpenFlow: Enabling Innovation in Campus Networks”, [online], [Searched on October 4, Heisei 23 (2011)], Internet <URL: http://www.openflow.org/documents/openflow-wp-latest.pdf>
NPL 2: “OpenFlow Switch Specification” Version 1.1.0 Implemented (Wire Protocol Ox02) [online] [Searched on October 4, Heisei 23 (2011)], Internet <URL: http://www.openflow.org/documents/openflow-spec-v1.1.0.pdf>

### SUMMARY OF INVENTION

### Technical Problem

The following analysis is given by the present invention. A plurality of terminals that are present on a same lower layer network need to have mutually different lower layer addresses (such as MAC addresses). For that reason, there is a problem that, when a plurality of terminals, each of which has a same lower layer address, are present on a plurality of networks, communication on the network cannot be normally performed.

In this respect, though Non Patent Literatures 1 and 2 describe that control from the OFC allows fine identification of a packet and then allows rewriting of the header of the packet or the like, as described above, Non Patent Literatures 1 and 2 do not disclose a configuration which is capable of implementing communication between terminals having the same lower layer addresses.

The present invention has been made in view of the above-mentioned situation. It is therefore an object of the invention to provide a control apparatus for forwarding apparatus(es), a control method for the forwarding apparatus(es), a communication system, and a program which is(are) capable of implementing communication even in an environment where uniqueness of lower layer addresses is not guaranteed.

### Solution to Problem

According to a first aspect, there is provided a control apparatus, wherein the control apparatus is connected to a group of forwarding apparatuses which forward a packet according to a forwarding rule, the control apparatus comprising:
an address storage unit that stores correspondence relationships between upper layer addresses and lower layer addresses;

an address management unit that refers to the address storage unit to search for a corresponding lower layer address from an upper layer destination address of a packet to be forwarded through one or more of the forwarding apparatuses; and
a forwarding rule setting unit that sets a forwarding rule for causing one of the forwarding apparatuses on a forwarding path of the packet, to write the searched lower layer address in a lower layer destination address field of the packet.

According to a second aspect, there is provided a communication system comprising:

a group of forwarding apparatuses which forward a packet according to a forwarding rule; and

a control apparatus comprising:

an address storage unit that stores correspondence relationships between upper layer addresses and lower layer addresses;

an address management unit that refers to the address storage unit to search for a corresponding lower layer address from an upper layer destination address of a packet to be forwarded through one or more of the forwarded apparatuses; and

a forwarding rule setting unit that sets a forwarding rule for causing one of the forwarding apparatuses on a forwarding path of the packet, to write the searched lower layer address in a lower layer destination address field of the packet.

According to a third aspect, there is provided a control method for forwarding apparatuses, wherein the control apparatus is connected to a group of forwarding apparatuses which forward a packet according to a forwarding rule, the control method comprising the steps of:

referring to an address storage unit that stores corresponding relationships between upper layer addresses and lower layer addresses to search for a corresponding lower layer address from an upper layer destination address of a packet to be forwarded through one or more of the forwarding apparatuses; and

setting a forwarding rule for causing one of the forwarding apparatuses on a forwarding path of the packet, to write the searched lower layer address in a lower layer destination address field of the packet. This method is linked with a specific machine, which is the control apparatus for each forwarding apparatus that forwards a packet according to the forwarding rule.

According to a fourth aspect, there is provided a program for a computer making up a control apparatus connected to forwarding apparatuses which forward a packet according to a forwarding rule, the program causing the computer to execute the processes of:

referring to an address storage unit that stores corresponding relationships between upper layer addresses and lower layer addresses to search for a corresponding lower layer address from an upper layer destination address of a packet to be forwarded through one or more of the forwarding apparatuses; and

setting a forwarding rule for causing one of the forwarding apparatuses on a forwarding path of the packet, to write the searched lower layer address in a lower layer destination address field of the packet. This program may be recorded in a computer readable recording medium. That is, the present invention may also be embodied as a computer program product.

### Advantageous Effects of Invention

According to the present invention, communication between terminals may be implemented even in an environment where uniqueness (uniqueness) of lower layer addresses is not guaranteed.

### BRIEF DESCRIPTION OF DRAWINGS

FIG. 1 is a diagram for explaining a schematic configuration and operation of an exemplary embodiment of the present invention.

FIG. 2 is a diagram showing a configuration of a first exemplary embodiment of the present invention.

FIG. 3 is a block diagram showing a configuration of a controller (control apparatus) in the first exemplary embodiment of the present invention.

FIG. 4 is a table showing configuration examples of entries registered in an address database held in the controller (control apparatus) in the first exemplary embodiment of the present invention.

FIG. 5 is a diagram showing an example of an interface correspondence table held in the controller (control apparatus) in the first exemplary embodiment of the present invention.

FIG. 6 is a flowchart showing a flow of processes when a packet has been received, in the first exemplary embodiment of the present invention.

FIG. 7 is a flowchart showing a flow of processes when an ARP packet has been received, in the first exemplary embodiment of the present invention.

FIG. 8 is a diagram schematically showing flows of transfer of an ARP request packet and an ARP response packet in the first exemplary embodiment of the present invention.

FIG. 9 is a flowchart showing a flow of a path establishment process in the first exemplary embodiment of the present invention.

FIG. 10 is a diagram schematically showing connecting relationships among switches and terminals in order to explain a specific operation of the present invention.

FIG. 11 is a table showing a configuration example of the address database associated with the connecting relationships shown in FIG. 10.

FIG. 12 is a table showing a configuration example of the interface correspondence table associated with the connecting relationships shown in FIG. 10.

FIG. 13 is a diagram showing an example of a shortest path tree in FIG. 10.

FIG. 14 is a flowchart showing a flow of a path establishment process in a second exemplary embodiment of the present invention.

FIG. 15 is a flowchart showing a flow of a path establishment process in a third exemplary embodiment of the present invention.

FIG. 16 is a diagram showing a reverse direction shortest path tree in FIG. 10.

FIG. 17 is a table showing an example of a routing table held by a controller in a fourth exemplary embodiment of the present invention.

FIG. 18 is a table showing a schematic configuration of a flow table held by an OpenFlow switch in Non Patent Literature 2.

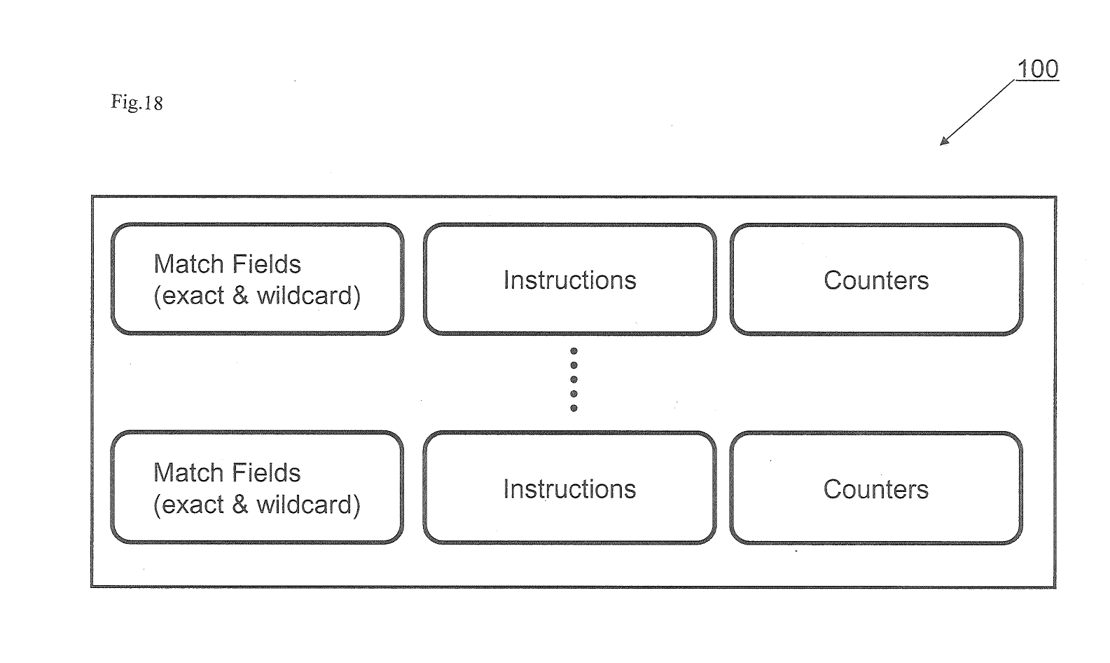

FIG. 19 is a table showing a header of an Ethernet (registered trademark)/IP/TCP packet.

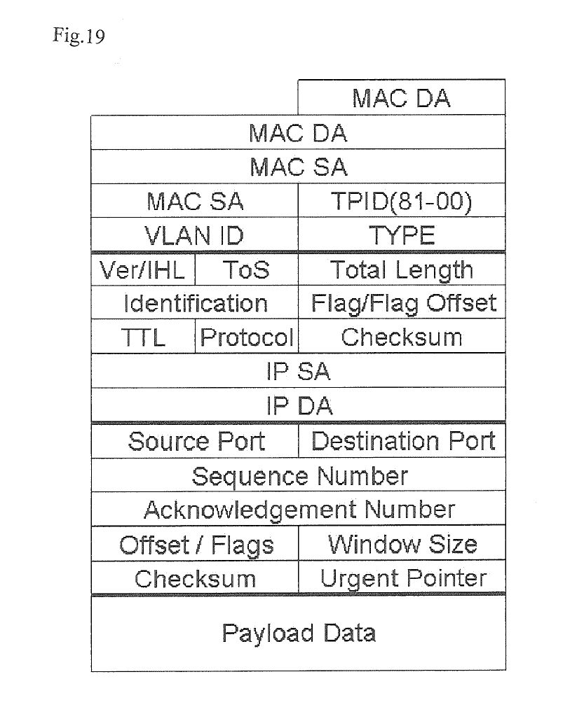

FIG. 20 is a table in Non Patent Literature 2 showing names of instructions that may be set in a forwarding rule (flow entry) and explanations of the instructions.

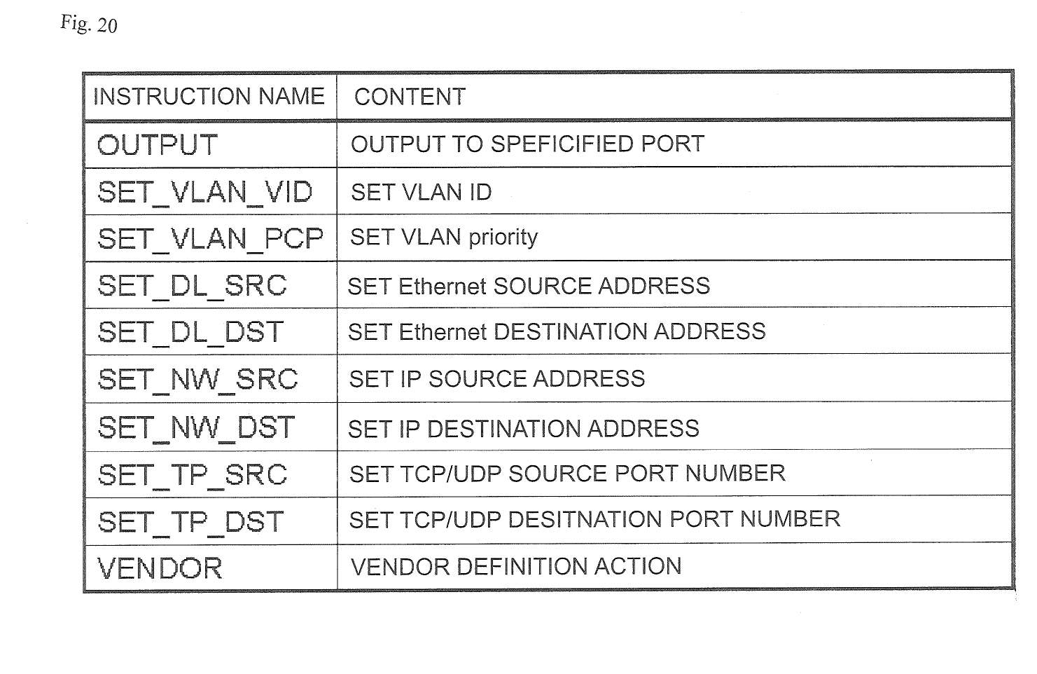

FIG. 21 is a table in Non Patent Literature 2 showing virtual ports to which an OFS may be instructed to output a packet and explanations of the virtual ports.

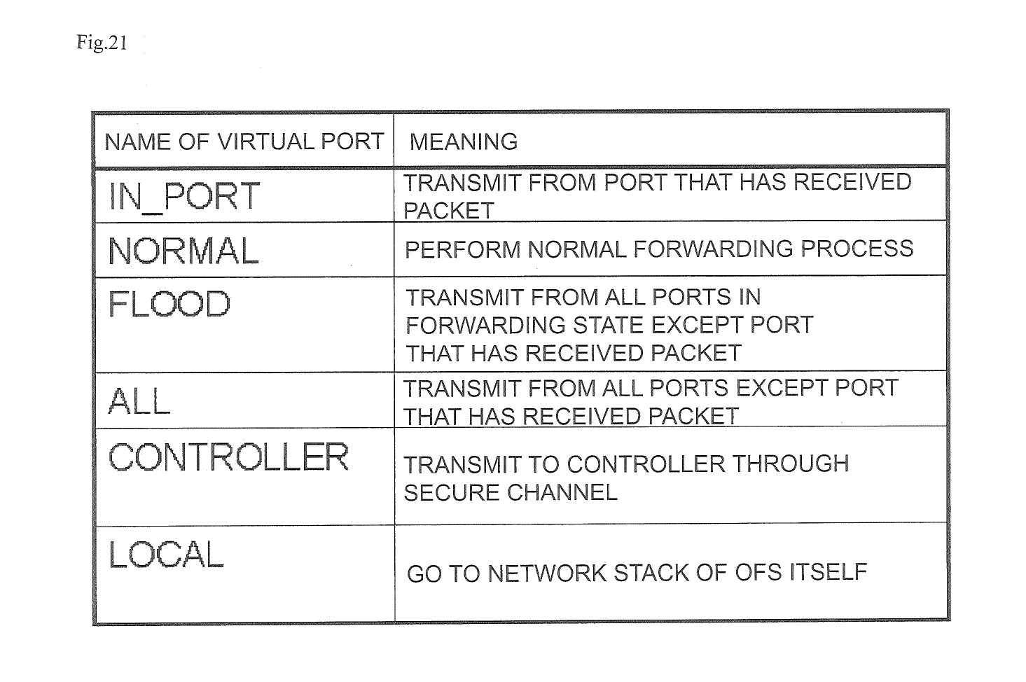

FIG. 22 is a table in Non Patent Literature 2 showing typical messages of an OpenFlow protocol and explanations of the messages.

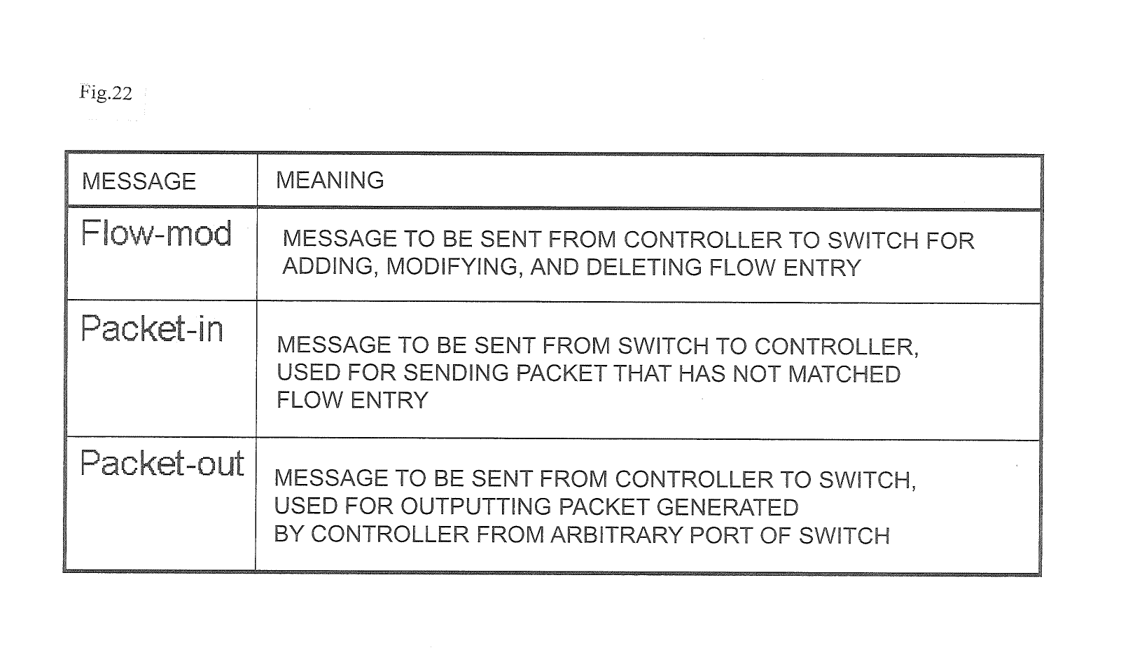

### DESCRIPTION OF EMBODIMENTS

First, a summary of an exemplary embodiment of the present invention will be described with reference to the drawings. Reference symbols in the drawings appended to this summary are appended to each element for convenience as an example for helping understanding of the disclosure, and are not intended to limit the present invention to the modes illustrated in the drawings.

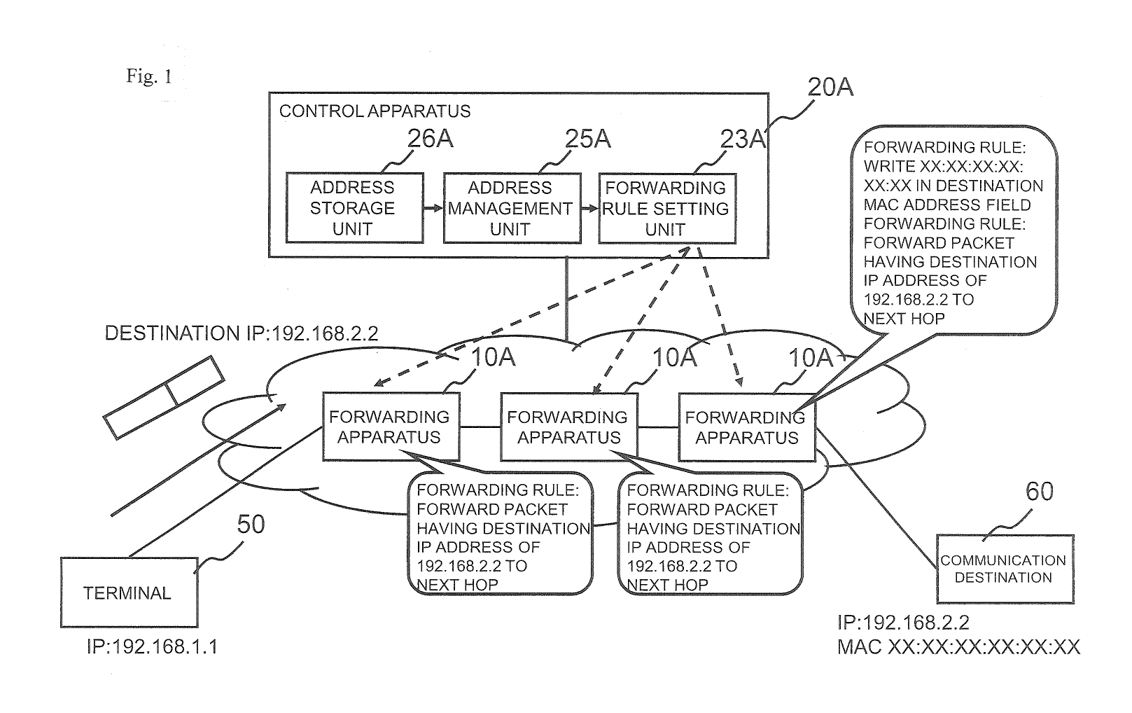

In an exemplary embodiment, the present invention may be implemented by a control apparatus 20A that controls a plurality of forwarding apparatuses 10A, as shown in FIG. 1. The forwarding apparatuses 10A is a communication apparatus that forwards a packet according to a forwarding rule, like an OFS described in the above-listed Non Patent Literatures 1 and 2.

The control apparatus 20A includes an address storage unit 26A that stores correspondence relationships between upper layer addresses and lower layer addresses, an address management unit 25A that refers to the address storage unit to search for a corresponding lower layer address from the upper layer destination address of a packet to be forwarded through one or more of the forwarding apparatuses, and a forwarding rule setting unit 23A that sets a forwarding rule for causing any one of the forwarding apparatuses on the forwarding path of the packet to be forwarded to perform a process of writing the searched lower layer address in the lower layer destination address field of the packet to be forwarded.

To take an example, the control apparatus 20A sets in each of the forwarding apparatuses between a terminal 50 and a communication destination 60 a forwarding rule for forwarding a packet, which is set an IP address of the communication destination 60 as a destination IP address, from the terminal 50 to the communication destination 60. Further, the control apparatus 20A causes any one of the forwarding apparatuses between the terminal 50 and the communication destination 60 (forwarding apparatus 10A on the right end of the page of FIG. 1) to write a MAC address (XX:XX:XX:XX:XX:XX) of the communication destination 60 associated with the IP address of the communication destination 60 in the destination MAC address field of the header of the packet.

With the above-mentioned arrangement, packet forwarding is implemented from the terminal 50 to the communication destination 60 in an environment where uniqueness of the lower layer addresses is not guaranteed. Referring to FIG. 1, the MAC address of each forwarding apparatus 10A is omitted, and since the forwarding apparatus 10A identifies the packet to be forwarded by using the destination IP address, there is no problem even if the MAC address of the forwarding apparatus 10A is the same as the MAC address of the communication destination. However, in order to implement communication in the reverse direction from the communication destination 60 to the terminal 50, it is necessary to also rewrite the MAC address of the transmission source. This operation will be described in detail in each of exemplary embodiments that will be described later.

### First Exemplary Embodiment

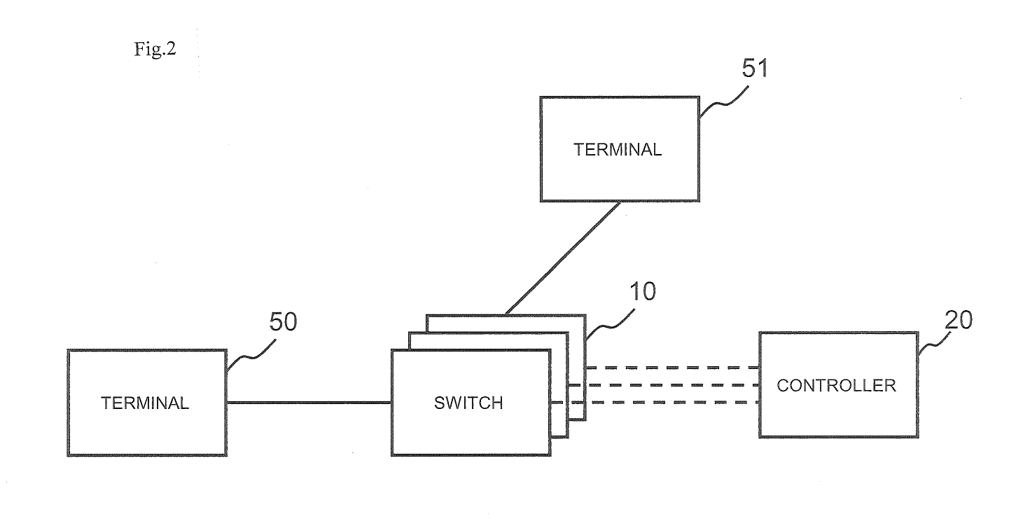

Next, a first exemplary embodiment of the present invention will be described in detail with reference to drawings. FIG. 2 is a diagram showing a configuration of the first exemplary embodiment of the present invention. Referring to FIG. 2, the configuration including a plurality of switches 10 that are disposed between terminals 50 and 51, and a controller 20 that controls these switches 10 is shown.

Each switch 10, which corresponds to the forwarding apparatus 10A described above, forwards a packet according to a forwarding rule (flow entry) that associates a matching rule for identifying the packet with processing content to be applied to the packet. The following description will be given, assuming that an OFS described in Non Patent Literature 1 is used as the switch 10. Besides the OFS, a communication apparatus that may perform equivalent packet processing may be used as the switch 10.

The controller 20, which corresponds to the above-mentioned control apparatus 20, sets the forwarding rule in each of the above-mentioned switches 10 and thereby controls the switches 10. The following description will be given, assuming that an apparatus based on the OFC described in Non Patent Literature 1 is used as the controller 20. Besides the OFC, a server or the like which may perform equivalent control may be used as the controller 20.

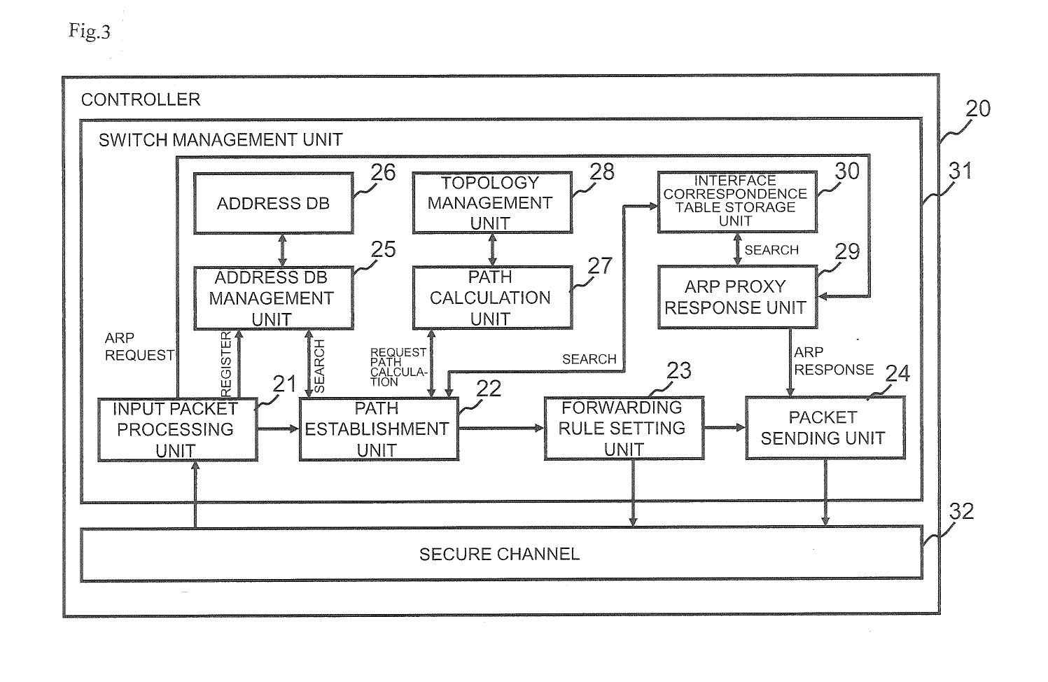

FIG. 3 is a block diagram showing a configuration of the controller (control apparatus) in the first exemplary embodiment of the present invention. Referring to FIG. 3, the configuration including a switch management unit 31 and a secure channel (communication unit) 32 that performs communication with each switch 10 in a network is shown.

The switch management unit 31 is configured to include an input packet processing unit 21, a path establishment unit 22, a forwarding rule setting unit 23, a packet sending unit 24, an address database management unit (address DB management unit) 25, an address database (address DB) 26, a path calculation unit 27, a topology management unit 28, an ARP proxy response unit 29, and an interface correspondence table storage unit 30.

The input packet processing unit 21 is a module where a packet, which is sent to the controller 20 from the switch 10, is received through the secure channel 32. Specifically, the input packet processing unit 21 determines the type of the input packet, and forwards the packet to the ARP proxy response unit 29 when the packet is an ARP Request packet (ARP request packet). On the other hand, when the input packet is a packet other than the ARP Request packet the input packet processing unit 21 forwards the input packet to the path establishment unit 22. The input packet processing unit 21 sends a set of the input switch (transmission source), the input port, the transmission source MAC address, and the transmission source IP address of the input packet to the address DB management unit 25.

The path establishment unit 22 makes an inquiry about the packet, which is sent from the input packet processing unit 21, to the address DB management unit 25, determines an end-point switch of the packet, and asks the path calculation unit 27 to calculate a shortest path to the end-point switch. Upon receipt of the shortest path, which is a result of the calculation, from the path calculation unit 27, the path establishment unit 22 generates a forwarding rule for forwarding the packet along the shortest path, and then sends the forwarding rule to the forwarding rule setting unit 23.

The forwarding rule setting unit 23 transmits the forwarding rule, which is sent from the path establishment unit 22, to each switch 10 through the secure channel 32. A Flow-mod message in Non Patent Literature 2 described above may be used for transmission of this forwarding rule.

The packet sending unit 24 instructs a specified one of the switches to output the packet, which is sent from the ARP proxy response unit 29, from the specified port of the switch through the secure channel 32 according to an instruction of the ARP proxy response unit 29.

The address DB management unit 25 registers in the address DB 26 an entry including the input switch, the port, the transmission source MAC address and the transmission source IP address of the packet sent from the input packet processing unit 21. Further, the address DB management unit 25 searches a corresponding entry to the path establishment unit 22 in the address DB 26 in response to a search request from the path establishment unit 22, and responds the corresponding entry to the path establishment unit 22.

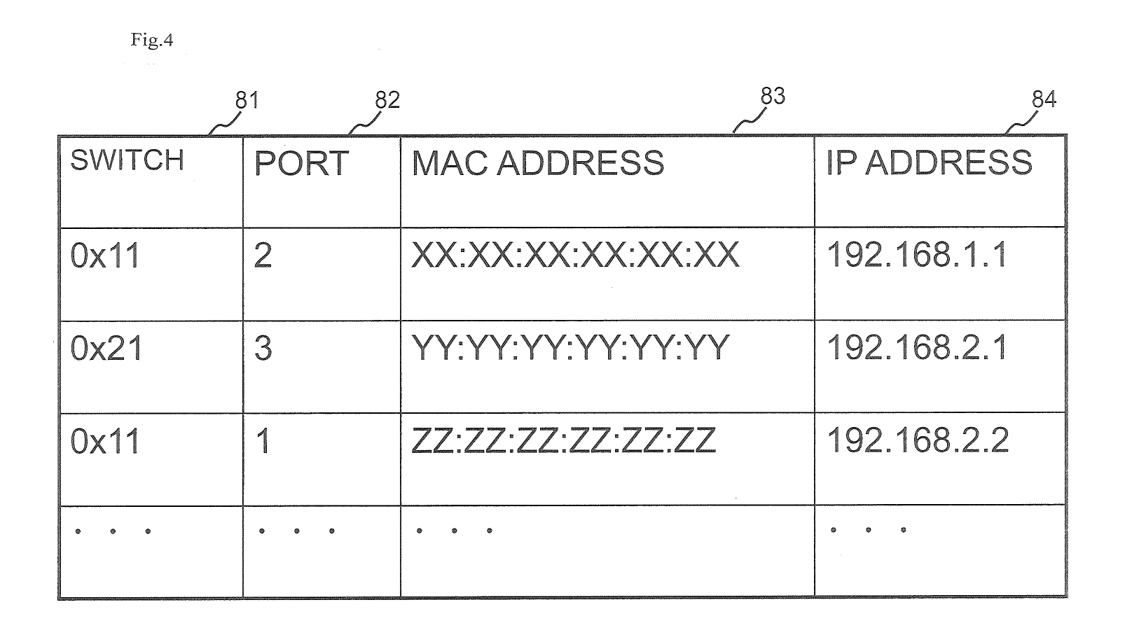

The address DB 26 is a database that stores an entry including at least the switch, the port, and the transmission source MAC address and the transmission source IP address of each packet. FIG. 4 is a table showing configuration examples of entries registered in the address DB 26. A switch field 81 and a port field 82 in FIG. 4 indicate a port of the switch that is connected by a terminal having addresses described in a MAC address field 83 and an IP address field 84. Herein, a Datapath ID in an OpenFlow protocol in Non Patent Literature 2 is used for switch identification. To take an example, a first entry in FIG. 4 shows that a terminal having a MAC address of XX:XX:XX:XX:XX:XX and an IP address of 192.168.1.1 is connected to a second port of the switch having a Datapath ID of 0x11. By referring to such an entry, the switch which serves as the end point of a packet with the destination IP address of 192.168.1.1, the port of the switch, and the MAC address of the terminal of a connection destination, for example, may be identified.

The path calculation unit 27 functions as a forwarding path calculation unit, calculates a path from a start point to an end point based on network topology information stored in the topology management unit 28, according to a request from the path establishment unit 22, and returns a result of the calculation to the path establishment unit 22.

The topology management unit 28 manages the topology information on the network formed of the switches managed by the controller 20, and provides the information to the path calculation unit 27. Herein, the topology information means information on the switches included in this network and information indicating how the switches are connected to one another. These pieces of information may be manually stored in advance by a manager. Alternatively, the controller may autonomously collect these pieces of information for storage by causing the respective switches to perform information exchange or the like.

The ARP proxy response unit 29 generates an ARP response packet, in response to the ARP Request packet sent from the input packet processing unit 21, and sends the ARP response packet to the packet sending unit 24.

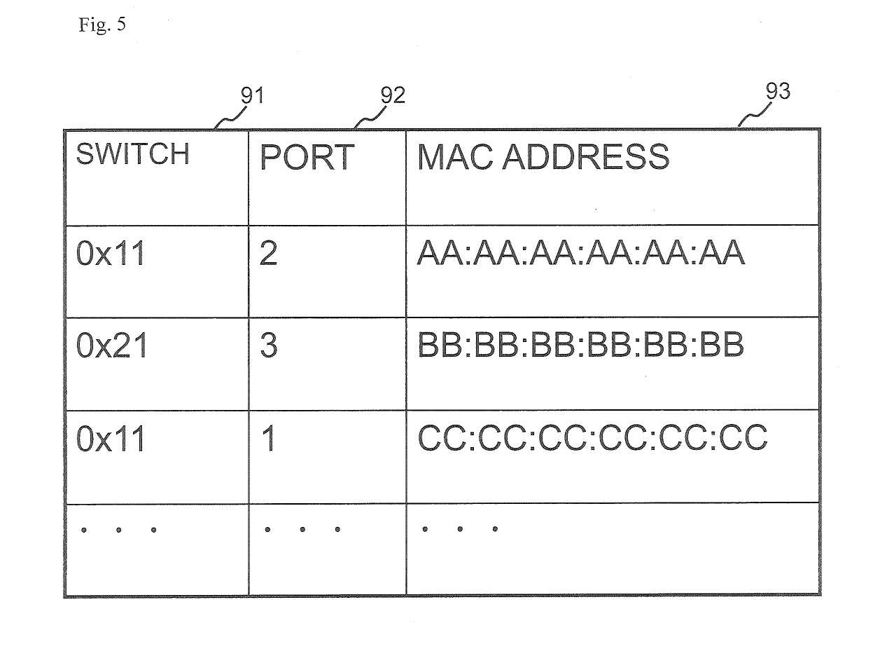

The interface correspondence table storage unit 30 stores an interface correspondence table in which a MAC address, which is included in an ARP response generated by the ARP proxy response unit 29, is held for each port of each switch that outputs the ARP response. FIG. 5 is a table showing an example of the interface correspondence table included in the controller (control apparatus). Information for switch identification such as the Datapath ID in the OpenFlow protocol mentioned above or the like is stored in a switch field 91 in FIG. 5. A port number is stored in a port field 92. The MAC address, which is to be responded when the port of the switch has received the ARP request packet, is stored in the port field 92. A first entry in FIG. 5, for example, shows that the MAC address of AA:AA:AA:AA:AA:AA should be responded to the ARP request packet that has arrived at the second port of the switch having the Datapath ID of 0x11.

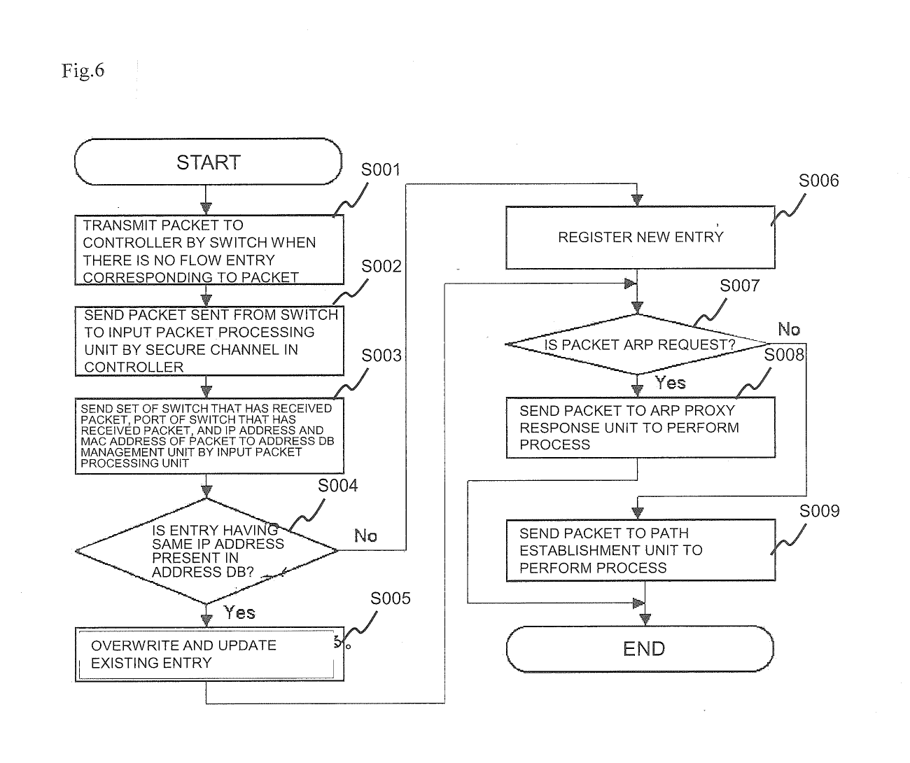

Next, operation of this exemplary embodiment will be described in detail with reference to drawings. FIG. 6 is a flowchart showing an outline of an operation when the switch 10 has received a new packet and has forwarded the new packet to the controller 20.

The switch 10 that has received the packet from an external connection port refers to the flow table of its own to search for a forwarding rule (flow entry) matching the received packet. When the forwarding rule matching the received packet is found, the switch applies a process described in the action of the forwarding rule to the received packet (which is not shown in FIG. 6). On the other hand, when the matching flow entry is not found, the switch 10 transmits the received packet to the controller 20 through the secure channel (in step S001). The above-mentioned Packet-in message in Non Patent Literature 2 may be used for transmission of the received packet to this controller 20.

The secure channel 32 that has received the received packet sent from the switch sends the received packet to the input packet processing unit 21 (in step S002).

The input packet processing unit 21 sends the identifier for the switch 10 that has received the packet, the port number of the switch 10 that has received the packet, the transmission source IP address and the transmission source MAC address of the packet to the address DB management unit 25 (in step S003).

Next, the address DB management unit 25 checks whether or not there is an entry having the same IP address in the address DB 26 as the IP address sent from the input packet processing unit 21 (in step S004).

When there is the entry having the same IP address in the address DB 26 as the IP address sent from the input packet processing unit 21, the address DB management unit 25 overwrites, in the existing entry, the identifier for the switch 10, the port number of the switch, and the transmission source MAC address of the packet sent in step S003 (in step S005).

On the other hand, when there is not the entry having the same IP address in the address DB 26 as the IP address sent from the input packet processing unit 21, the address DB management unit 25 registers a new entry including the identifier for the switch 10, the port number of the switch, and the transmission source IP address and the transmission source MAC address of the packet sent in step S003, in the address DB 26 (in step S006).

The processes in the above-mentioned steps S003 to S006 are phases where the address DB 26 learns the correspondence relationship between the IP address and the MAC address of a terminal that has transmitted the packet and information on the switch 10 connected to the terminal and the port of the switch 10 connected to the terminal. These pieces of information may be set in advance by the manager, for example. Alternatively, information generated by a different system such as a management system may be used for these pieces of information. In these cases, the above-mentioned processes in steps S003 to S006 may be omitted.

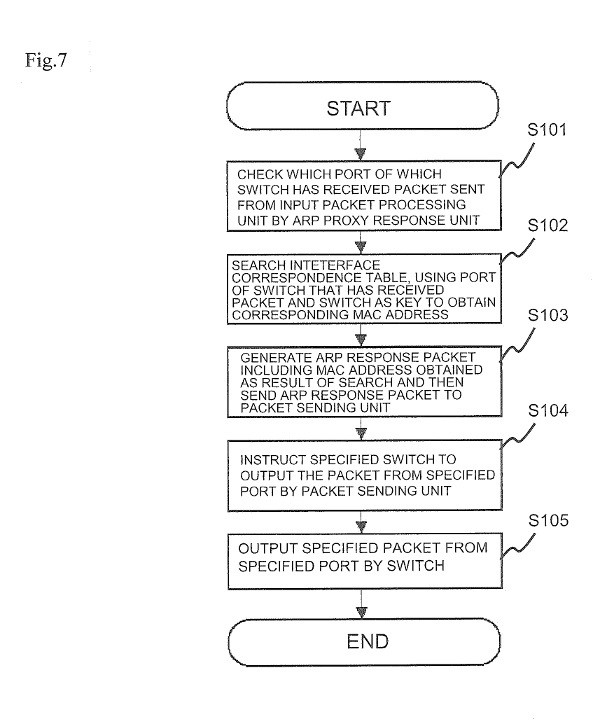

Next, the input packet processing unit 21 checks whether or not the received packet is an ARP request packet (in step S007), When the received packet is the ARP request packet, this packet is sent to the ARP proxy response unit 29 and an ARP proxy response process is performed (in step S008; refer to FIG. 7).

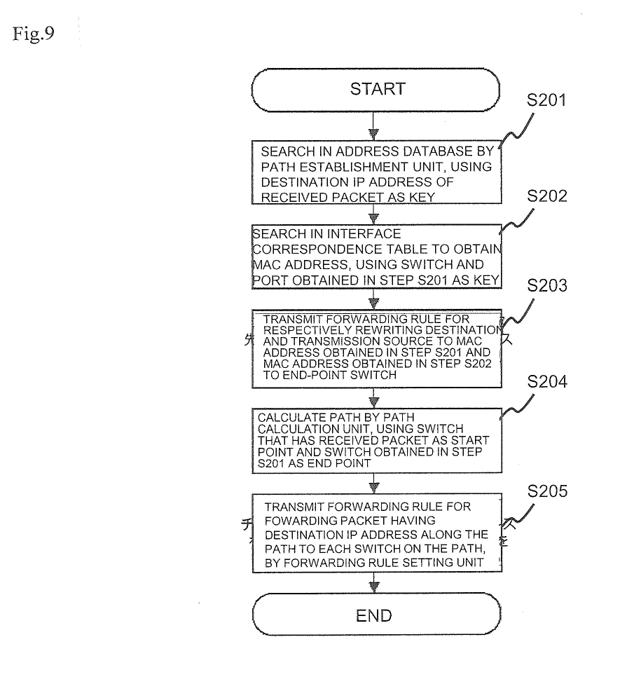

On the other hand, when the received packet is not the ARP request packet, the received packet is sent to the path establishment unit 22 and a path establishment process is performed (in step S009; refer to FIG. 9).

Next, details of the ARP proxy response process in step S008 in FIG. 6 will be described in detail, with reference to FIG. 7.

The ARP proxy response unit 29 checks the port of the switch which has received the ARP request packet sent from the input packet processing unit 21 (in step S101). The ARP proxy response unit 29 can obtain the transmission source switch and the port of the transmission source switch which sends the ARP request packet by making an inquiry to the input packet processing unit 21. The input packet processing unit 21 may transmit the ARP request packet and information on the switch and the port of the switch to the ARP proxy response unit 29.

Next, the ARP proxy response unit 29 searches the interface correspondence table of the interface correspondence table storage unit 30 for the corresponding entry, using the identifier for the switch and the port number of the switch, which is obtained as a result of the checking in step S101 as a key, and the ARP proxy response unit 29 thereby obtains the corresponding MAC address (in step S102).

Next, the ARP proxy response unit 29 generates an ARP response packet that responds the MAC address, which is a result of the search in step S102, and sends the ARP response packet to the packet sending unit 24 (in step S103).

The packet sending unit 24 outputs to the switch, which is obtained by the checking in step S101, a message instructing output of the ARP response packet generated in step S103 from the port obtained by the checking in step S101 through the secure channel 32 (in step S104). For instructing output of this ARP response packet, the above-mentioned Packet-out message in Non Patent Literature 2 may be used.

The switch 10 that has received the instruction of outputting the ARP response packet outputs the ARP response packet from the specified port (in step S105).

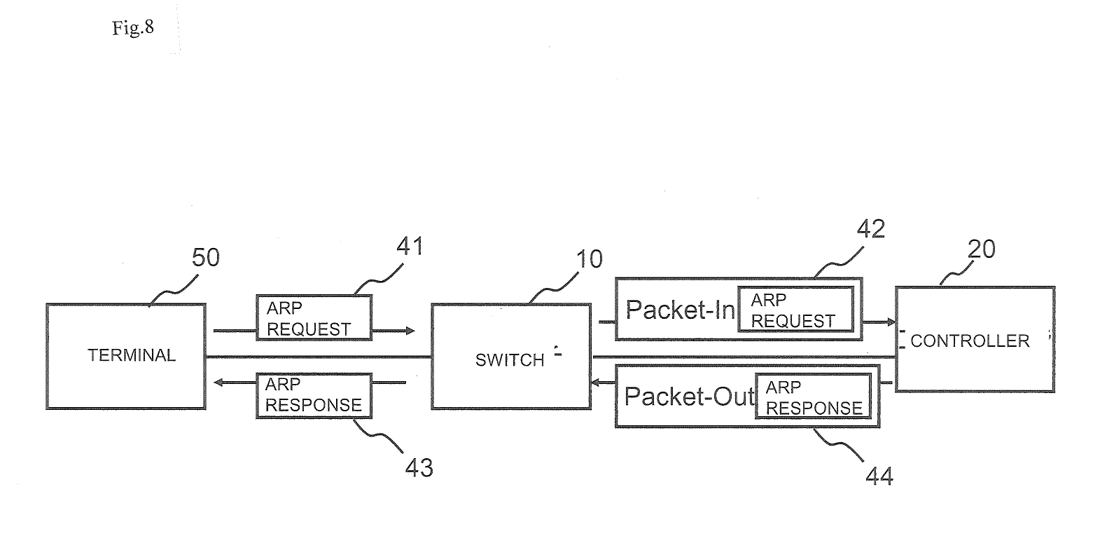

FIG. 8 is a diagram schematically showing flows of transfer of the ARP request packet and the ARP response packet. The switch 10, which has received an ARP request (packet) 41 transmitted by the terminal 50, transmits a Packet-in message 42 including the ARP request (packet) to the controller 20 through the secure channel 32.

The controller 20 performs the above-mentioned processes in steps S101 to S103 in FIG. 7. Further, the controller 20 transmits a Packet-out message 44 including the ARP response (packet) to the switch 10, as described in step S104 in FIG. 7.

As described in step S105 in FIG. 7, the switch 10 outputs an ARP response (packet) 43 from the specified port, according to the Packet-out message 44.

As described above, the ARP request from the terminal connected to the network is forwarded to the controller 20 through the switch 10, and then the MAC address stored in the interface correspondence table is responded by the ARP proxy response unit 29 inside the controller.

Next, details of the path establishment process by the path establishment unit in step S009 in FIG. 6 will be described in detail, with reference to FIG. 9. Referring to FIG. 9, the path establishment unit 22 searches in the address DB 26 through the address DB management unit 25, using as a key, the destination IP address of the received packet sent from the input packet processing unit 21, thereby obtaining the identifier for the switch (end-point switch) to which the terminal having the IP address is connected, the port number of the switch, and the MAC address of the terminal having the IP address (in step S201).

Next, the path establishment unit 22 searches the interface correspondence table of the interface correspondence table storage unit 30 for the corresponding entry, using, as a key, the identifier for the switch and the port number of the switch, which is obtained in step S201, to obtain the MAC address assigned to the port of the corresponding switch (or end-point switch) (in step S202).

The MAC address obtained in step S201 is the MAC address of the terminal of a transmission destination obtained from a result of learning the correspondence relationship between the IP address and the MAC address of the terminal, as described in steps S001 to S006 in FIG. 6. On the other hand, the MAC address obtained in step S202 is the MAC address assigned to the port of the switch, and is used as the MAC address of the transmission source.

The path establishment unit 22 generates a forwarding rule for causing a process of rewriting the destination to the MAC address obtained in step S201 and rewriting the transmission source to the MAC address obtained in step S202 to be performed, and then outputs the forwarding rule to the forwarding rule setting unit 23. Then, the forwarding rule setting unit 23 transmits the forwarding rule to the switch for which the search has been performed in step S201 through the secure channel 32 (in step S203).

Next, the path calculation unit 27 calculates the path using the switch that has first received the received packet as a start point and using the switch obtained in step S201 as an ending point, according to the request from the path establishment unit 22 (in step S204).

Calculation of this path is performed using Dijkstra's algorithm or the like, based on the network topology information held in the topology management unit 28. Herein, the description will be given, assuming that Dijkstra's algorithm is employed. Other path calculation algorithms, however, may also be employed.

Upon receipt of a result of the calculation by the path calculation unit 27, the path establishment unit 22 generates a forwarding rule for causing each switch on the path to forward the packet having the destination IP address along the path, and then outputs the forwarding rule to the forwarding rule setting unit 23. The forwarding rule setting unit 23 then transmits the forwarding rule to each switch on the path through the secure channel 32 (in step S205).

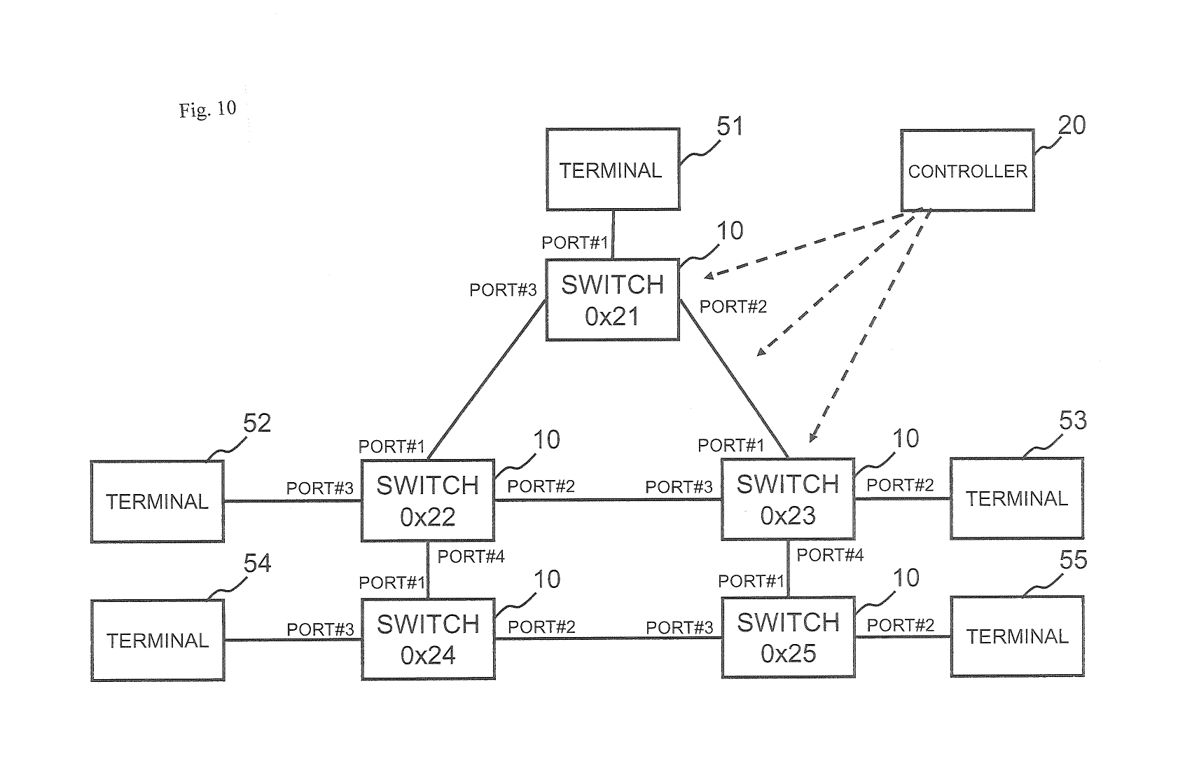

A more specific description will be given about a flow of the above-mentioned processes, using FIGS. 10 to 13. To take an example, a switch 10 (0x21) in FIG. 10 has received a packet having a destination IP address of 192.168.Z.15 from a terminal 51.

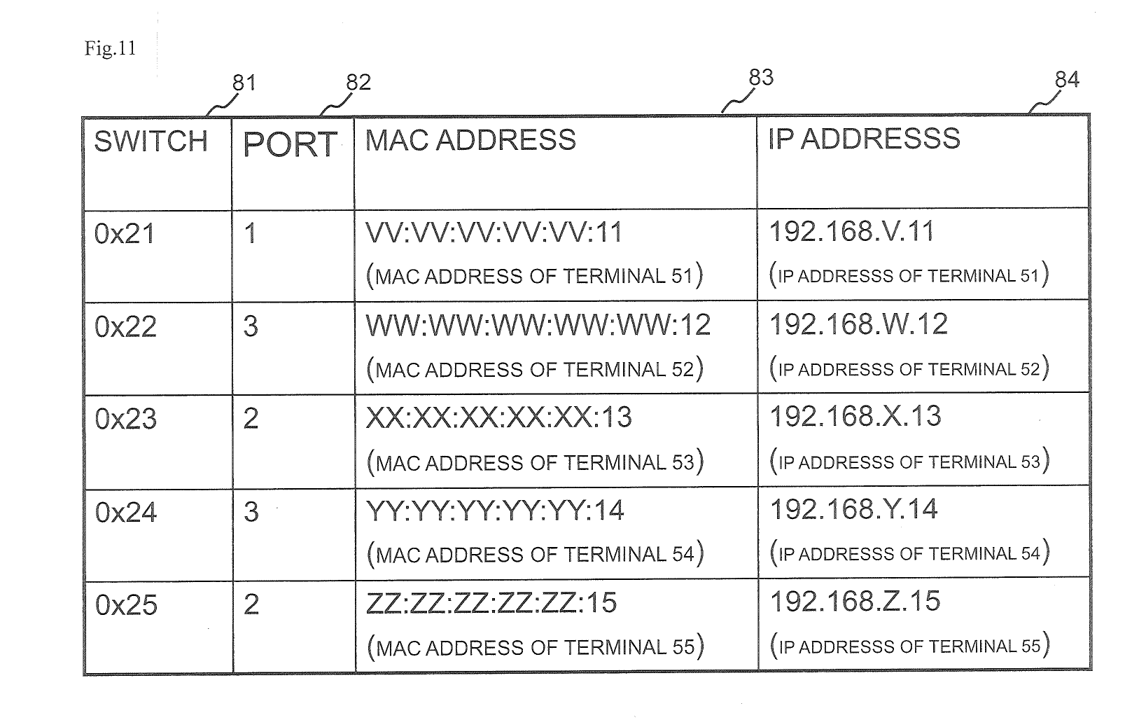

FIG. 11 is a table showing a configuration example of the address DB 26 associated with connecting relationships in FIG. 10. Referring to FIG. 11, it can be seen that a terminal having the IP address of 192.168.Z.15 is a terminal 55 connected to a port #2 of a switch 10 (0x25), and that the MAC address of this terminal 55 is ZZ:ZZ:ZZ:ZZ:ZZ:15.

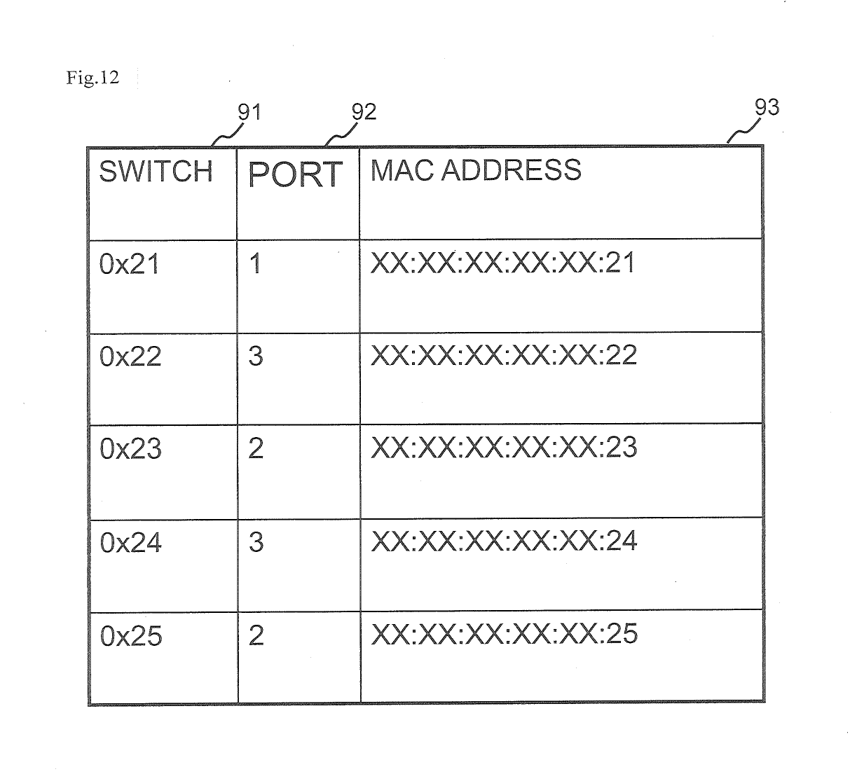

FIG. 12 is a table showing a configuration example of the interface correspondence table associated with the connecting relationships in FIG. 10. Next, referring to the interface correspondence table in FIG. 12, it can be seen that the MAC address corresponding to the port #2 of the switch 10 (0x25) is XX:XX:XX:XX:XX:25.

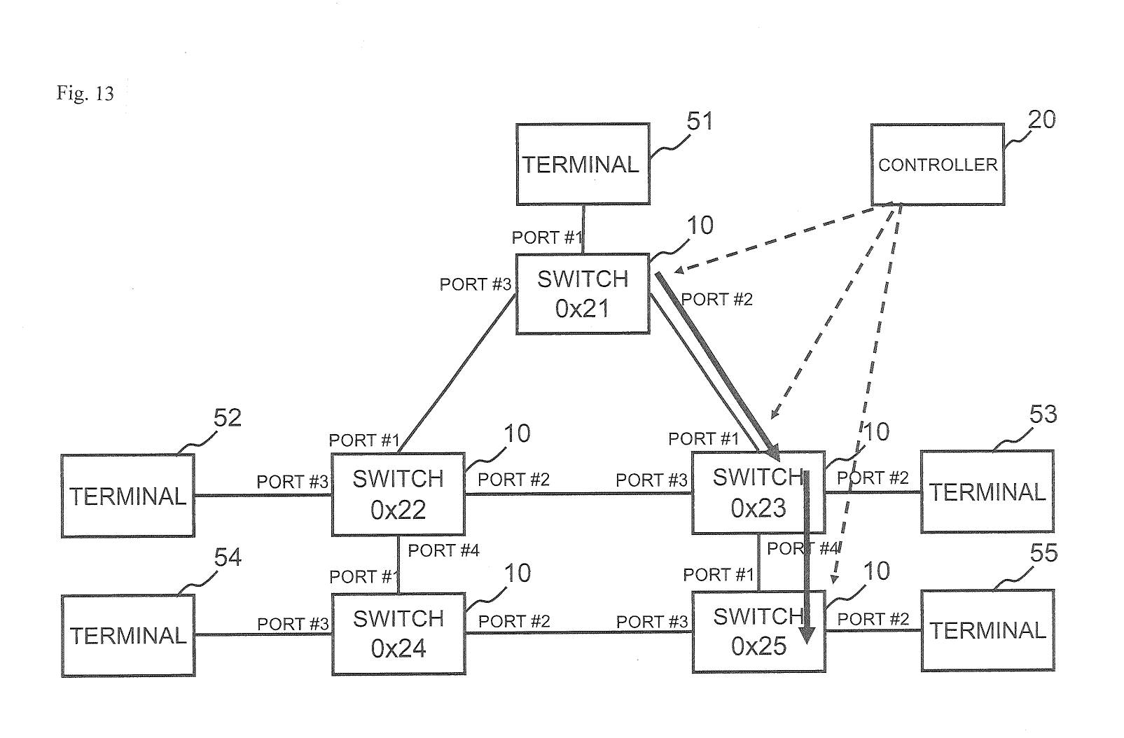

In this case, the switch 10 (0x21) that has received the packet from the terminal 51 serves as a start point and the switch 10 (0x25) serves as an end point. By using the Dijkstra's algorithm, a shortest path tree that reaches the switch 10 (0x25) through a switch 10 (0x23) using the switch 10 (0x21) as the start point, as shown in FIG. 13, may be calculated.

In order to forward the packet along the above-mentioned path, a forwarding rule for outputting the packet, which has the destination IP address of 192.168.Z.15 to a port #2 connected to the switch 10 (0x23), is transmitted to the switch 10 (0x21). Similarly, a forwarding rule for outputting the packet, which has the destination IP address of 192.168.Z.15 to a port #4 connected to the switch 10 (0x25), is transmitted to the switch 10 (0x23). A forwarding rule for rewriting the transmission source MAC address to XX:XX:XX:XX:XX:25 (MAC address of the port #2 of the switch 10 (0x25)) and rewriting the transmission destination MAC address to ZZ:ZZ:ZZ:ZZ:ZZ:15 and then outputting the packet having the destination IP address of 192.168.Z.15 to the port #2 connected to the terminal 55, is transmitted to the switch 10 (0x25).

By controlling the a groups of switches 10 as described above, a packet may be forwarded to a target destination, even if uniqueness of lower layer addresses is not guaranteed.

In the above-mentioned exemplary embodiment, the description was given, IP addresses are used as upper layer addresses and MAC addresses are used as the lower layer addresses. The upper layer addresses and the lower layer addresses are not limited to this combination. IPv6 addresses, for example, may be used as the upper layer addresses. The exemplary embodiment may be similarly carried out even if arbitrary upper layer addresses and arbitrary lower layer addresses are used. In the above-mentioned exemplary embodiment, the description was given, that the controller 20 includes the ARP proxy response unit 29 and the ARP proxy response unit 29 responds the MAC address corresponding to the IP address. Besides that, a lower layer address response unit for a lower layer, which responds to an inquiry about an upper layer address and is comparable to the ARP proxy response unit 29, may be included.

### Second Exemplary Embodiment

Next, a second exemplary embodiment of the present invention will be described in detail with reference to drawings. In the second exemplary embodiment, the path establishment process (refer to FIG. 9) in the above-mentioned first exemplary embodiment is modified to rewrite a MAC address earlier than in the first exemplary embodiment. Since the second exemplary embodiment of the present invention may be implemented by a configuration that is substantially the same as that of the above-mentioned first exemplary embodiment, a description will be given below, centering on a difference between the first exemplary embodiment and the second exemplary embodiment.

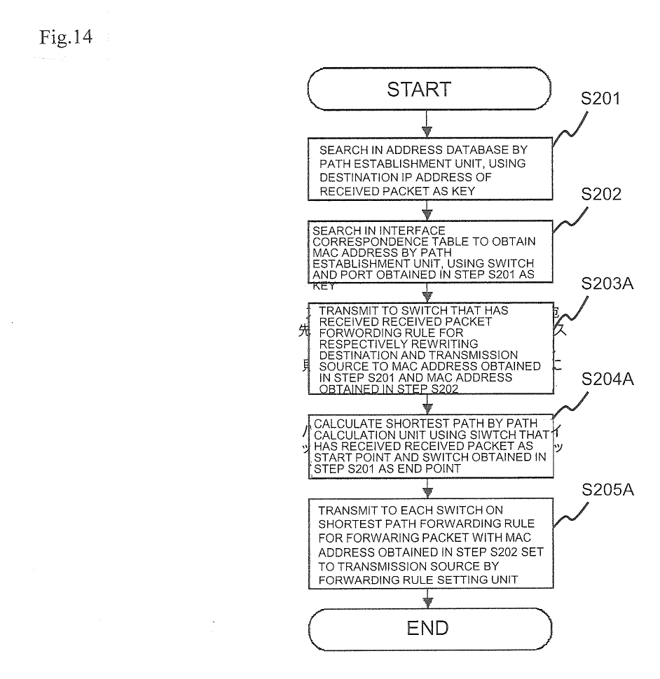

FIG. 14 is a flowchart showing a flow of a path establishment process in the second exemplary embodiment of the present invention. As compared with the flow of the path establishment process in the first exemplary embodiment shown in FIG. 9, processes in steps S201 and S202 are the same as those in the first exemplary embodiment, and processes after step S203A are different from those in the first exemplary embodiment.

In this exemplary embodiment, a path establishment unit 22 generates a forwarding rule for rewriting MAC address using the MAC address (MAC address of a transmission destination terminal) obtained in step S201 as a destination and the MAC address (MAC address of the output port of an end-point switch) obtained in step S202 as a transmission source, and then outputs the forwarding rule to a forwarding rule setting unit 23. The forwarding rule setting unit 23 then transmits the forwarding rule to the switch that has received the received packet through a secure channel 32 (in step S203A).

Next, a path calculation unit 27 calculates a shortest path where the switch that has received the received packet is set to a start point and the switch obtained in step S201 is set to an end point (in step S204A).

Then, the path establishment unit 22 generates, for each switch on the shortest path, a forwarding rule for forwarding, along the shortest path, the packet with the transmission source MAC address rewritten in step S203A, and outputs the forwarding rule to the forwarding rule setting unit 23. The forwarding rule setting unit 23 transmits the forwarding rule to each switch on the shortest path (in step S205A).

A more specific description will be given about the flow of the above-mentioned processes, using FIGS. 10 to 13 again. For example, a switch 10 (0x21) in FIG. 10 has received a packet having a destination IP address of 192.168.Z.15 from a terminal 51.

Referring to FIG. 11, it can be seen that a terminal having the IP address of 192.168.Z.15 is a terminal 55 connected to a port #2 of a switch 10 (0x25), and that the MAC address of this terminal 55 is ZZ:ZZ:ZZ:ZZ:ZZ:15.

FIG. 12 is the diagram showing the configuration example of the interface correspondence table associated with the connecting relationships in FIG. 10. Next, referring to the interface correspondence table in FIG. 12, it can be seen that the MAC address corresponding to the port #2 of the switch 10 (0x25) is XX:XX:XX:XX:XX:25. Further, a shortest path tree from the switch 10 (0x21) to the switch 10 (0x25) is as shown in FIG. 13.

As shown in step S203A in FIG. 14, the transmission source MAC address of the packet having the IP address of 192.168.Z.15 is rewritten to XX:XX:XX:XX:XX:25. Then, the transmission destination MAC address of the packet is rewritten to ZZ:ZZ:ZZ:ZZ:ZZ:15. Then, the switch 10 (0x21) outputs the packet which has been rewritten from a port #2.

Then, a forwarding rule for outputting the packet which has MAC address being XX:XX:XX:XX:XX:25 to a port #4 connected to a switch 10 (0x23), is transmitted to the switch 10 (0x25). A forwarding rule for outputting the packet which has source MAC address being XX:XX:XX:XX:XX:25, is transmitted to the port #2 of the switch 10 (0x25) connected to the terminal 55.

As described above, MAC address rewriting is performed at the switch disposed before the end-point switch. Then, by referring to the transmission source MAC address, the MAC address rewriting has been performed at the switches disposed after the switch at which MAC address rewriting is performed, the packet is forwarded. The number of these transmission source MAC addresses is just the number of switch ports connected to external terminals in this network (which is five in the example in FIG. 10).

In the first exemplary embodiment, it is necessary to handle a lot of different destination IP addresses in order to identify a packet to be forwarded. In this exemplary embodiment, packet identification may be performed by a transmission source MAC address. Thus, the number of forwarding rules to be set in each switch may be reduced, so that the process of searching the forwarding rule may be performed at high speed.

### Third Exemplary Embodiment

Next, a third exemplary embodiment of the present invention, in which the path establishment process in the above-mentioned second exemplary embodiment is performed in advance, will be described in detail with reference to drawings. The third exemplary embodiment of the present invention is different from the second exemplary embodiment in that a forwarding rule associated with a path is set before communication is actually performed. The other respects may be implemented by a configuration that is substantially the same as the configuration of the second exemplary embodiment. A description will be therefore given, centering on the difference between the second and third exemplary embodiments.

In the above-mentioned second exemplary embodiment, a shortest path is calculated in one of a series of processes to be carried out when a packet has been received by the switch 10 (refer to step S204A in FIG. 14), and a forwarding rule for implementing the path is set in each switch on the path (refer to step S205A in FIG. 14).

In this exemplary embodiment, by performing an establishment process of a path extending in reverse direction of the shortest path in advance, reduction of a period of time for allowing a packet to be forwarded after receipt of the packet is achieved.

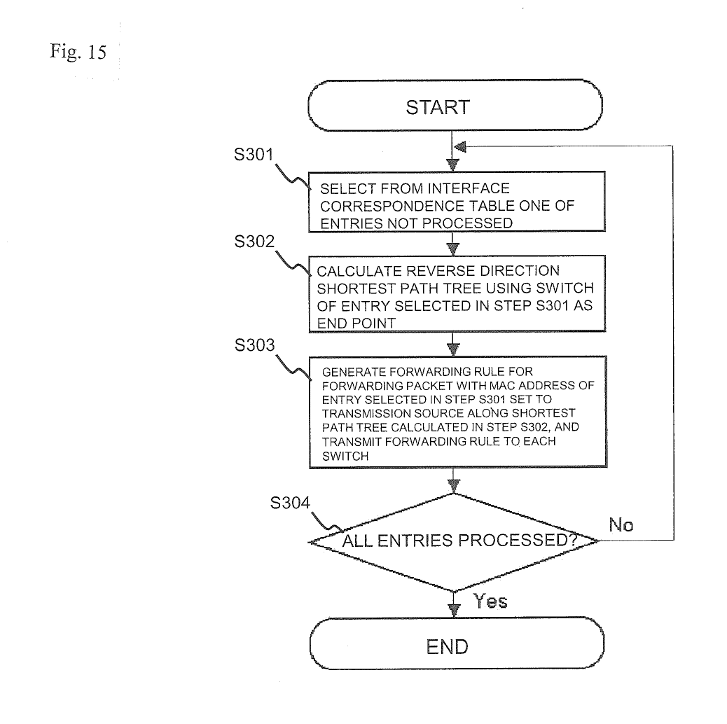

FIG. 15 is a flowchart showing a flow of a path establishment process in the third exemplary embodiment of the present invention. Referring to FIG. 15, a path establishment unit 22 first selects one of entries that is not processed from an interface correspondence table stored in an interface correspondence storage unit 30 (in step S301).

Next, the path establishment unit 22 asks a path calculation unit 27 to calculate a shortest path tree extending in a reverse direction using the switch, in which the entry selected in step S301 is set, as an end point (in step S302).

Upon receipt of a result of the calculation of the reverse direction path, the path establishment unit 22 generates a forwarding rule for forwarding a packet, which includes the MAC address of the entry selected in step S301 as a transmission source, along the shortest path tree calculated in step S302, and outputs the generated forwarding rule to a forwarding rule setting unit 23. The forwarding rule setting unit 23 transmits the forwarding rule to each switch on the shortest path (in step S303).

Next, the path establishment unit 23 checks whether or not calculation of a reverse direction path and transmission of a forwarding rule have been performed for each entry. When the calculation of a reverse direction path and the transmission of a forwarding rule have not been performed for each entry, the operation is returned to step S301 and the processes in steps S302 and S303 are performed. On the other hand, when the calculation of a reverse direction path and the transmission of a forwarding rule have been performed for each entry, all the processes are finished.

The above description was given, calculation of a reverse direction path and transmission of a forwarding rule are performed. Calculation of a forward direction path and transmission of a forwarding rule may be also performed using a similar procedure. By performing the series of processes as described above in advance when the controller 20 is activated or the like, the processes in steps S203 (S203A) to S205 (S205A) in FIG. 9 (FIG. 14) do not needed to be formed whenever a packet has been received.

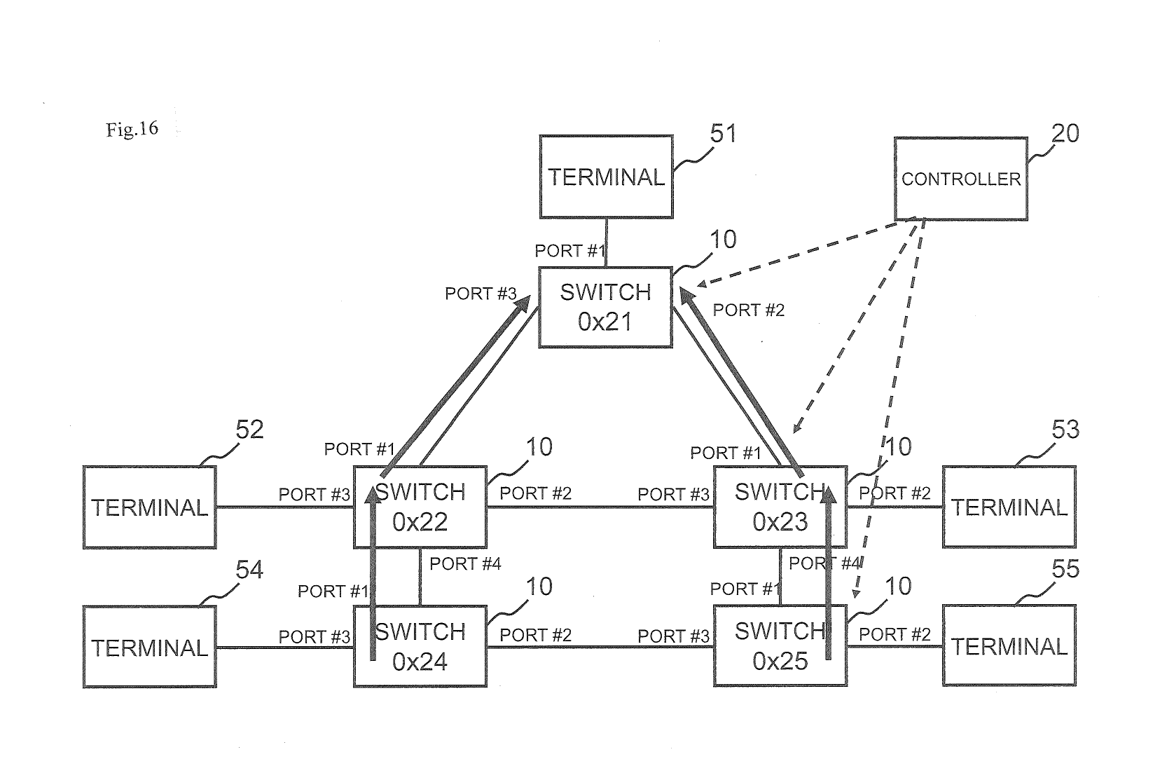

In the case of a first entry in the interface correspondence table in FIG. 12 associated with connecting relationships in FIG. 10, for example, the MAC address of a port #1 of a switch 0x21 is XX:XX:XX:XX:XX:21. FIG. 16 shows a reverse direction shortest path tree whose end point is the switch 0x21. A forwarding rule is set so that a packet is forwarded along this shortest path tree. Specifically, the forwarding rule is set, which indicates that the packet having the transmission source MAC address of XX:XX:XX:XX:XX:21 is forwarded to the port #1 of the switch 0x21, to a port #1 of a switch 0x22, to a port 2 of a switch 0x23, to a port 1 of a switch 0x24, and to a port 4 of a switch 0x25.

As described above, compared with the first and second exemplary embodiments, a path is established in advance in this exemplary embodiment. Thus, it is possible to reduce a period of time for allowing a packet to be forwarded after receipt of the packet.

### Fourth Exemplary Embodiment

In the first exemplary embodiment of the present invention, the path establishment unit 22 searches in the address DB 26 using a destination IP address as a key, in step S201 in FIG. 9. When a terminal having the destination IP address is directly connected to an OpenFlow network, a corresponding entry is supposed to be found by this search. However, when the terminal having the destination IP address is connected to the OpenFlow network through a router apparatus or the like and is not directly connected to the OpenFlow network, the corresponding entry may not be able to be searched from the address DB 26.

A fourth exemplary embodiment of the present invention that has made it possible to accommodate such a case will be described in detail with reference to drawings. The fourth exemplary embodiment may be implemented by substantially the same configuration as those in the above-mentioned first to third exemplary embodiments. Thus, the following description will be given, centering on a difference from the first to third exemplary embodiments.

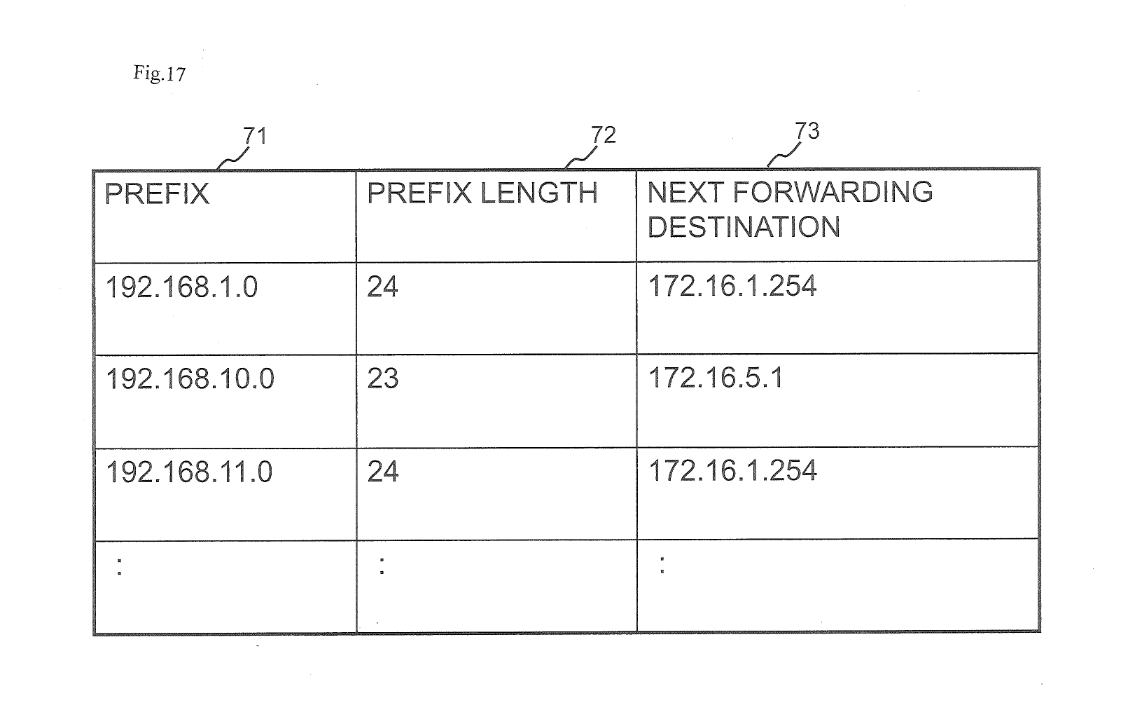

A controller in the fourth exemplary embodiment of the present invention holds a routing table shown in FIG. 17 in storage means of which illustration is omitted, in order to accommodate the case as mentioned above. When the corresponding entry is not found in step S201 in FIG. 9, the path establishment unit 22 performs a longest prefix match search for the destination IP address using this routing table, thereby determining a next forwarding destination.

The longest prefix match herein is a search method in which, when there are a plurality of matching entries by the search, an entry having a longest prefix length is selected. When the destination IP address is 192.168.11.1, for example, second and third entries in FIG. 17 match, and the third entry having the longest prefix length is therefore selected. Accordingly, the next forwarding destination is 172.16.1.254.

In this exemplary embodiment, the address DB 26 is referred to again, with respect to this next forwarding address to determine a lower layer address. Subsequent processes are the same as those after step S202 in FIG. 9 in the first exemplary embodiment of the present invention.

As described above, according to this exemplary embodiment, it is possible to accommodate even the case where the terminal having the destination IP address is not directly connected to the OpenFlow network.

When the routing table as mentioned in the fourth exemplary embodiment is held, step S205 in FIG. 9 may be modified as follows. In the forwarding rule to be transmitted in step S205 in FIG. 9 in the first exemplary embodiment, a destination IP address is used as a portion to be checked for a received packet. The prefix and the prefix length of an entry obtained by a search using the routing table may be used in place of this destination IP address. When the destination IP address is 192.168.11.1, for example, the forwarding rule is generated in which a packet with its prefix/prefix length matching 192.168.11.0/24 is to be processed. In this case, a packet having a destination of 192.168.11.2 is also processed in a similar manner The number of flow entries in each switch may be saved.

The above description was given about each exemplary embodiment of the present invention. The present invention is not, however, limited to the above-mentioned exemplary embodiments. The present invention may be further varied, replaced, and adjusted without departing from the basic technical concept of the present invention. The numbers and the connecting relationship of the switches (forwarding apparatuses) and the controller (control apparatus) shown in each exemplary embodiment described above are shown for briefly explaining the present invention, and may be changed as appropriate.

The OpenFlow, which is a related art, is referred to in each exemplary embodiment described above. The present invention is not, however, limited to use of the OpenFlow. The present invention may also be applied to a communication architecture in which a packet forwarding path is concentrically controlled by the control apparatus.

Each disclosure of the Patent and Non Patent literatures listed above is incorporated herein by reference. Modifications and adjustments of the exemplary embodiments and examples are possible within the scope of the overall disclosure (including claims) of the present invention, and based on the basic technical concept of the invention. Various combinations and selections of various disclosed elements (including each element of each claim, each element of each example, each element of each drawing, and the like) are possible within the scope of the claims of the present invention. That is, the present invention of course includes various variations and modifications that could be made by those skilled in the art according to the overall disclosure including the claims and the technical concept.

### REFERENCE SIGNS LIST

10 switch
10A forwarding apparatus
20 controller
20A control apparatus
21 input packet processing unit
22 path establishment unit
23 forwarding rule setting unit
23A forwarding rule setting unit
24 packet sending unit
25 address database management unit (address DB management unit)
25A address management unit
26 address database (address DB)
26A address storage unit
27 path calculation unit
28 topology management unit
29 ARP proxy response unit
30 interface correspondence table storage unit
31 switch management unit
32 secure channel (communication unit)
50˜55 terminal
60 communication destination
81, 91 switch field
82, 92 port field
83, 93 MAC address field
84 IP address field
100 flow table

What is claimed is:

1. A control apparatus, wherein the control apparatus is connected to a group of forwarding apparatuses which forward a packet according to a forwarding rule, the control apparatus comprising:
an address storage unit that stores correspondence relationships between upper layer addresses and lower layer addresses;
an address management unit that refers to the address storage unit to search for a corresponding lower layer address from an upper layer destination address of a packet to be forwarded through one or more of the forwarding apparatuses; and
a forwarding rule setting unit that sets a forwarding rule for causing one of the forwarding apparatuses on a forwarding path of the packet, to write the searched lower layer address in a lower layer destination address field of the packet.

2. The control apparatus according to claim 1, further comprising:
a lower layer address response unit that responds a lower layer address provided in advance through the one or more of the forwarding apparatuses, in response to an inquiry about the lower layer address corresponding to the upper layer destination address, wherein the inquiry is received through the one of the one or more of the forwarding apparatuses.

3. The control apparatus according to claim 2, further comprising:
an interface correspondence table storage unit that stores an interface correspondence table in which the lower layer address provided in advance is included, wherein the lower layer address is associated for each port of the forwarding apparatuses connected to an outside;
the lower layer address response unit referring to the interface correspondence storage unit to determine the lower layer address to be responded, based information on the forwarding apparatus that has received the inquiry about the lower layer address corresponding to the upper layer address and the port of the forwarding apparatus.

4. The control apparatus according to claim 3, wherein
the forwarding rule setting unit further searches the interface correspondence table for the lower layer address corresponding to the forwarding apparatus that has received the packet to be forwarded and the port of the forwarding apparatus that has received the packet to be forwarded, and sets a forwarding rule for writing the searched lower layer address in a lower layer transmission source address field of the packet.

5. The control apparatus according to claim 1, wherein
the forwarding rule setting unit further generates a second forwarding rule for forwarding the packet along the forwarding path from the forwarding apparatus that received the packet to a forwarding apparatus that serves as an end point, and sets the second forwarding rule in each forwarding apparatus on the forwarding path.

6. The control apparatus according to claim 5, wherein
the forwarding path rule setting unit generates, as the second forwarding rule, a forwarding rule for identifying the packet, using the upper layer destination address or a prefix of the upper layer destination address.

7. The control apparatus according to claim 5, wherein
the forwarding path rule setting unit generates, as the second forwarding rule, a forwarding rule for identifying the packet, using the lower layer address of a transmission source.

8. The control apparatus according to claim 1, further comprising:
a forwarding path calculation unit that calculates the forwarding path from the forwarding apparatus that has received the packet which is forwarded to a forwarding apparatus that serves as an end point.

9. The control apparatus according to claim 8,
wherein the upper layer addresses and the lower layer addresses in the address storage unit are associated with the forwarding apparatus which is connected to an external apparatus having the upper layer address and the lower layer address, and port information of the forwarding apparatus; and
wherein the forwarding apparatus that serves as the end point and port of the forwarding apparatus are determined from the upper layer destination address of the packet, by referring to the address storage unit.

10. The control apparatus according to claim 1, wherein
the address management unit registers in the address storage unit a set of an upper layer transmission source address and a lower layer transmission source address of the packet to be forwarded.

11. The control apparatus for forwarding apparatuses according to claim 10, wherein
the address management unit further registers in the address storage unit information on the forwarding apparatus connected to the external apparatus having the upper layer address and the lower layer address and port of the forwarding apparatus in association with the upper layer address and the lower layer address.

12. The control apparatus according to claim 8, wherein
the forwarding path calculation unit further calculates a reverse path extending in a reverse direction of the forwarding path, using the forwarding apparatus, which serves as the end point on the forwarding path, as a start point and using the forwarding apparatus, which has received the packet to be forwarded, as an end point; and
the forwarding rule setting unit further generates a third forwarding rule for forwarding the packet along the reverse path, and sets the third forwarding rule in each forwarding apparatus on the reverse path.

13. A communication system, comprising:
a group of forwarding apparatuses which forward a packet according to a forwarding rule; and
a control apparatus comprising:
an address storage unit that stores correspondence relationships between upper layer addresses and lower layer addresses;
an address management unit that refers to the address storage unit to search for a corresponding lower layer address from an upper layer destination address of a packet to be forwarded through one or more of the forwarded apparatuses; and
a forwarding rule setting unit that sets a forwarding rule for causing one of the forwarding apparatuses on a forwarding path of the packet, to write the searched lower layer address in a lower layer destination address field of the packet.

14. A control method for forwarding, wherein the control apparatus is connected to a group of forwarding apparatuses which forwards a packet according to a forwarding rule, the control method comprising the steps of:
referring to an address storage unit that stores corresponding relationships between upper layer addresses and lower layer addresses to search for a corresponding lower layer address from an upper layer destination address of a packet to be forwarded through one or more of the forwarding apparatuses; and
setting a forwarding rule for causing one of the forwarding apparatuses on a forwarding path of the packet, to write the searched lower layer address in a lower layer destination address field of the packet.

15. (canceled)

16. The control apparatus according to claim 2, wherein
the forwarding rule setting unit further generates a second forwarding rule for forwarding the packet along the forwarding path from the forwarding apparatus that received the packet to a forwarding apparatus that serves as an end point, and sets the second forwarding rule in each forwarding apparatus on the forwarding path.

17. The control apparatus according to claim 3, wherein
the forwarding rule setting unit further generates a second forwarding rule for forwarding the packet along the forwarding path from the forwarding apparatus that received the packet to a forwarding apparatus that serves as an end point, and sets the second forwarding rule in each forwarding apparatus on the forwarding path.

18. The control apparatus according to claim 4, wherein
the forwarding rule setting unit further generates a second forwarding rule for forwarding the packet along the forwarding path from the forwarding apparatus that received the packet to a forwarding apparatus that serves as an end point, and sets the second forwarding rule in each forwarding apparatus on the forwarding path.

19. The control apparatus according to claim 2, further comprising:
a forwarding path calculation unit that calculates the forwarding path from the forwarding apparatus that has received the packet which is forwarded to a forwarding apparatus that serves as an end point.

20. The control apparatus according to claim 3, further comprising:
a forwarding path calculation unit that calculates the forwarding path from the forwarding apparatus that has received the packet which is forwarded to a forwarding apparatus that serves as an end point.

21. The control apparatus according to claim 4, further comprising:
a forwarding path calculation unit that calculates the forwarding path from the forwarding apparatus that has received the packet which is forwarded to a forwarding apparatus that serves as an end point.
